(19) United States
(12) Patent Application Publication
(10) Pub. No.: US 2011/0109426 A1
(43) Pub. Date: May 12, 2011

(54) METHOD, DEVICE, AND SYSTEM FOR SECURED ACCESS TO GATED AREAS

(76) Inventors: Zion Harel, Kadima (IL); Avish Jacob Weiner, Tel Aviv (IL)

(21) Appl. No.: 12/973,731

(22) Filed: Dec. 20, 2010

Related U.S. Application Data
(63) Continuation-in-part of application No. 12/068,023, filed on Jan. 31, 2008.
(60) Provisional application No. 60/898,704, filed on Feb. 1, 2007.

(51) Int. Cl. G08B 29/00

(52) U.S. Cl. 340/5.6; 340/5.7

(57) ABSTRACT

Embodiments of the present invention allow vehicular ingress and egress to an automotive facility using a mobile communication device, such as a smart phone, having thereon a software application adapted to communicate with a gate unit. The mobile communication device may transmit one or more parameters to the gate unit, which may determine whether to open a gate or which may transmit the parameters to a server, which may determine whether to allow or deny access.

### CROSS REFERENCE TO RELATED APPLICATIONS

This application is a Continuation in Part (CIP) application of U.S. application Ser. No. 12/068,023, filed on Jan. 31, 2008 and entitled “METHOD AND SYSTEM FOR FEE PAYMENT FOR AUTOMOTIVE SERVICES”, which claims priority from U.S. Provisional Patent Application Ser. No. 60/898,704, filed on Feb. 1, 2007 and entitled “METHOD AND SYSTEM FOR FEE PAYMENT FOR AUTOMOTIVE SERVICES”, both of which are incorporated in their entirety herein by reference.

### FIELD OF THE INVENTION

The field of the present invention relates to telecommunication systems and methods for use in connection with automotive services, e.g., parking.

### BACKGROUND OF THE INVENTION

Known secured access systems may control access to gated areas such as, for example, automotive facilities or parking lots. Such secured access systems may identify a user or a user's car through various communication systems, for example, by license plate number, credit card details, subscription code, etc. Once the user is identified, the access systems may charge or debit the client for access permission to the gated area and/or for the services provided in the gated area.

In the last decade, smart mobile phones (or smart phones) have become very common and popular not only as telephone devices, but also for various other applications. Smart phone users carry their mobile phones everywhere and use them, for example, for listening to music, accessing networks, such as the internet, communicating by email, GPS navigation, purchasing goods and/or services, and many other applications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for secured access to a gated area according to embodiments of the present invention;

FIG. 2 is a more detailed schematic illustration of the gate unit described in FIG. 1 for controlling secured access to a gated area according to embodiments of the present invention; and

FIG. 3 is a flowchart illustrating a method for secured access to a gated area according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may provide a system and method for utilizing a mobile telecommunication unit (such as a cellular phone or another mobile unit connectable to a communications network), for secured access to a gated area, for example, an off-street automotive facility, such as a parking garage or gated parking lot. Although the embodiments discussed herein generally make reference to cellular phones, whose cellular networks are generally available in public areas, the system and method according to embodiments of the present invention are not so limited, and may be implemented by any suitable wireless mobile unit connectable to an available wireless network, e.g., satellite phone, WiFi device, etc.

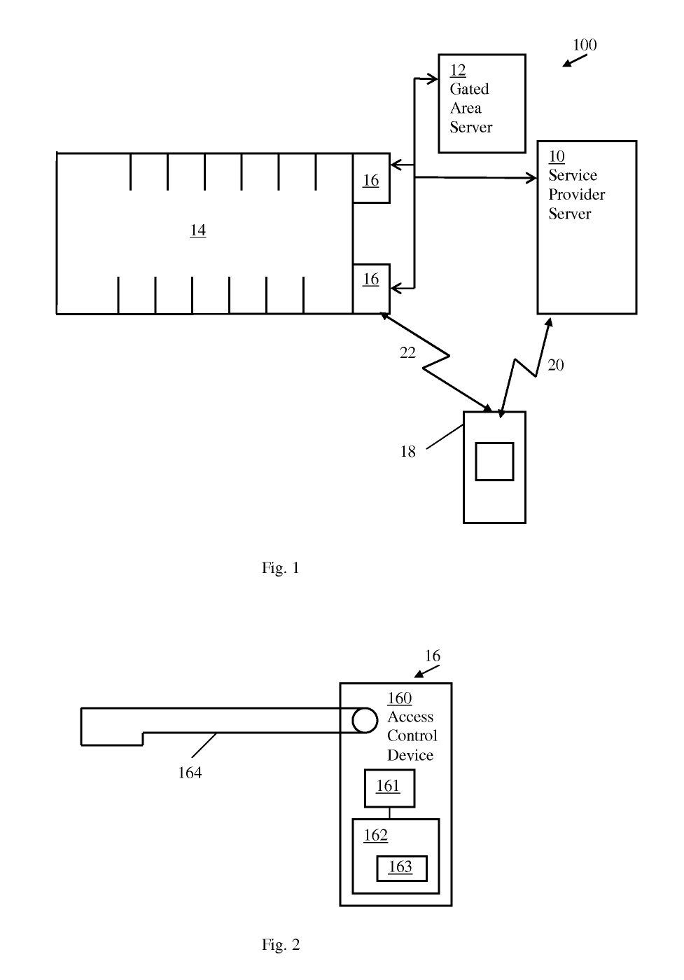

Reference is now made to FIG. 1, which is a schematic illustration of a system 100 for secured access to a gated area 14 according to embodiments of the present invention. System 100 may include service provider server 10, gated area server 12, gate units 16 and a mobile unit 18. As described in detail herein below, mobile unit 18 may communicate with service provider server 10 over a wireless connection 20. For example, mobile unit 18 may be a cellular phone or another unit connectable to a cellular network. Additionally, mobile unit 18 may communicate with gate units 16 over a wireless connection 22, which may be, for example, a Bluetooth connection.

Gated area 14 may be any gated area which may require payment and/or a special permission in order to enter and/or spend time within this area. Specifically, gated area 14 may be a gated area for entering with cars, such as a parking lot or any other automotive facility. In another example, gated area 14 may be a leisure and/or entertainments center which may be entered and traveled by car, such as, for example, a nature reserve or a safari park.

Gate units 16 may control access to and/or exit from gated area 14, for example, by controlling gates or barriers (shown in FIG. 2) at corresponding points of entry to and/or points of exit from gated area 14. For example, one of gate units 16 may be used as an exit gate unit at a point of exit from gated area 14, and another gate unit 16 may be used as an entry gate at a point of entry to gated area 14. Although FIG. 1 schematically shows two gate units 16, gated area 14 may be guarded by any suitable number of gate units 16, or, for example, may include only one point of entry/exit and a corresponding gate unit 16. As described in further detail below, in order to enable access to and/or exit from gated area 14, gate units 16 may receive a key code and/or a user identification code from mobile unit 18, check the validity of the received key code and/or the identity of the user, and determine whether to enable access to gated area 14 based on whether the key code is valid and/or based on the user's identity, e.g. whether the user is permitted. The key code may be received by communication from mobile unit 18 over a wireless connection 22, for example, by a short-range telecommunication medium, e.g., Bluetooth connection, RFID, 802.11, 802.16, etc. Gate units 16 may include, for example, one or more antennas (shown in FIG. 2) for communicating with mobile units such as mobile unit 18, for example, by Bluetooth technology.

Gate units 16 may communicate with gated area server 12, which may be associated with gated area 14. Gated area server 12 may receive, store and/or provide information and updates regarding entries to and exits from gated area 14. Gated area server 12 may receive and gather information and updates from the various gate units 16 of gated area 14, for example, regarding entries to and exits from gated area 14. Gated area server 12 may count entries to and exits from gated area 14 and may notify gate units 16 in case, for example, gated area 14 is fully populated and no additional entries should be allowed. Subsequently, in the event a parking space in gated area 14 is vacated, gated area server 12 may notify gate units 16 that additional entries may be allowed. In some embodiments of the present invention, gated area server 12 may receive, store and/or provide information and updates regarding access permissions to users. For example, gated area server 12 may manage a list of non-permitted users (a “black list”) and/or of permitted users (a “white list”) and may provide information and/or updates about the black list and/or white list to gate units 16.

Service provider server 10 may provide key codes to registered users for access to gated areas such as gated area 14. A user of mobile unit 18 may register with service provider server 10, for example, by communication over a wireless connection 20, over the internet, and/or by other means. Upon registration, the user may receive, for example, into a memory of mobile device 18, one or more key codes for access to gated areas such as gated area 14. The key code may be valid for a certain period of time or for a limited number of uses or locations, and may include indication about the validity of the key code. By communicating a suitable and valid key code to gate unit 16, the user may enter and/or exit from gated area 14.

In order to register to service provider server 10, the user of mobile unit 18 may be required to provide to service provider server 10 details about mobile unit 18 such as, for example, an associated phone number or another identification in order to enable communication with mobile unit 18 when needed. Additionally, the user may be required to provide to service provider server 10 payment means details such as credit card details or bank account details which may enable the service provider to charge money for the access to gated areas and/or for the time spent inside the gated areas. In some embodiments of the present invention, in case mobile unit 18 is a cellular phone, the service provider may be associated with, or otherwise have business relationship with the cellular network provider, which may enable the service provider to charge money directly for services through the cellular phone account. Additional details may be required, such as car details and/or other identification details.

In some embodiments of the present invention, service provider server 10 may include gated area server 12 and/or perform some or all of the functions of gated area server 12 mentioned herein.

In some embodiments of the present invention, a user of mobile unit 18 may download a software application from service provider server 10, which may be adapted to communication with the gate units in order to enable access to gated areas for registered users with a valid key code according to embodiments of the present invention. The software application may be downloaded to mobile unit 18, e.g., via a wired or wireless internet connection, by WiFi, or simply preloaded by a service provider, and may be installed and run on mobile unit 18. Mobile unit 18 may include a memory to store parameters and other data, a processor (not shown) to run the software application, and a communication module to communicate with the gate unit antenna. In some embodiments, the download may be enabled upon registration of the user to service provider server 10. The service provider's software application may enable communication between mobile device 18 and gated units 16, such as, for example, transmission of key codes and additional information such as user identifications from mobile unit 18 to gated units 16. For example, a user may use a button or other indication means in the software application to request access into or out from gated area 14. In some embodiments, the application may automatically sense the proximity of a gate unit and communicate the required parameters automatically. Upon receipt of the user's request, the software application may trigger transmission of a request message to the relevant gate unit 16. The request message may transmit information to the gate unit, which may include, for example, a key code received from the service provider and/or identification of the user or user device. The transmitted information may also include additional data such as, for example, a telephone number associated with the mobile unit.

The request message sent to gate unit 16 by the software application installed in mobile unit 18 may specify whether the user wishes to exit or enter gated area 14. For example, the service provider's software application may include an “exit” button and an “enter” button to be used by the user for requesting access out from gated area 14 or for requesting access into gated area 14, respectively. In some embodiments, the device may automatically determine whether entry or exit is requested. For example, if an entry request was previously made with no corresponding exit request, a mobile device may determine that a request is to exit. In another example, the gate unit may be an entry unit or an exit unit, and there may not be a need for a dedicated interaction for entry or exit. Upon receipt of the user's request, the software application may trigger transmission of a corresponding exit or entry request message to the gate unit 16. Accordingly, in some embodiments of the present invention, a gate unit 16 may be configured for either exit or entry, and may not be activated by an incompatible request. For example, a gate unit 16 which is configured for entry may not be activated by an exit request, and vice versa. This may prevent an error which may occur in case a gate unit 16 at an exit of gated area 14 may be activated by an entry request and vice versa, which may happen, for example, in case the exit and entry of gated area 14 are adjacent. In some other embodiments of the present invention, gate units 16 may be activated by a general access request without specification whether the request is for entry or exit. Accordingly, the service provider's software application may include a single button to be used by the user for requesting access out from gated area 14 or for requesting access into gated area 14. In these cases, other means may be used in order to prevent activation of a wrong gate unit 16, as described later on in this document.

In some embodiments of the present invention, each gate unit 16 may be identified with an identification code which may include, for example, an array of characters such as numbers and/or letters. In order to activate a certain gate unit 16, a user may be required to enter, for example, at mobile unit 18, the correct identification code associated with the specific gate unit 16 and send it to the gate unit 16, for example, by the software application installed on mobile unit 18, thus, for example, addressing the request message to the correct gate unit 16. The identification code may be sent to gate unit 16 before, after or together with the transmission of the access request message by the software application.

Further, in some embodiments of the present invention, in case the transmission of the access request is received at a gate unit 16 that is not associated with the entered identification code, the request may be transmitted by the receiving gate unit 16 to the correct gate unit 16, i.e. the gate unit 16 that is associated with the entered identification code. The transmission of messages between gate units 16 may be performed by direct communication between gate units 16, e.g. via direct connection, or via gated area server 12 which may receive transmissions and relay them to the correct gate units 16. When the correct gate unit 16 receives the access request, the correct gate unit 16 may be activated to enable access into or out from gate area 14.

In some embodiments of the present invention, in case the request message sent to gate unit 16 by the mobile software application is an exit request message and/or in case the request message is addressed to an exit gate unit 16 at a point of exit from gated area 14, gate unit 16 may not enable exit from gated area 14 if no corresponding preceding entry request (or access request sent to an entry gate unit) by the same user has been received. Access requests, which may include specified entry and/or exit requests and/or access requests sent to entry gate units or exit gate units, may be stored at gated area server 12 and/or at gated units 16. The access requests information may be transmitted to gate units 16 by direct communication between gate units 16, e.g. via direct connection, or via gated area server 12.

In some embodiments of the present invention, upon receipt of the user's request, the software application may check the key code sent by mobile device 18 for validity, and then trigger transmission of the request message to gate unit 16 in case the key code is valid. In case the key code is not valid, the software application may refrain from sending the request message, and therefore, for example, gate unit 16 will not enable access into or out from gated area 14. In some embodiments of the present invention, the software application may notify the user that the key code he is holding is not valid. In some embodiments of the present invention, the software application may communicate with gate unit 16 before sending the request message, in order to receive identification of gate unit 16 and, for example, to make sure that gate unit 16 is related to the services provided by the service provider associated with the software application. In case gate unit 16 is not identified as related to the services provided by the service provider, the software application may refrain from sending the request message.

Upon receipt of the request message from mobile unit 18, gate unit 16 may identify the user and decide whether to enable access to gated area 14 based on whether the key code is valid and/or based on the user's identity, e.g. whether the user is permitted. Gate unit 16 may check whether the key code is valid (for example, in case the validity is not checked by the software application or in addition to the examination performed by the software application). Additionally, in some embodiments of the present invention, gate unit 16 may receive, for example, together with the request message, an identification of the software application, and may check the authenticity of the software application based on the received identification. Therefore, in case the software application that sent the request message is not an authentic software application provided by the service provider, gate unit 16 may prevent access to gated area 14, e.g., by not activating the gate.

In some cases, not every user having a valid key code may enter gated area 14. For example, in addition to having a valid key code, a user may require permission to enter gated area 14. In such cases, when the user is identified, gate unit 16 may check whether the identified user has permission to enter to gated area 14. For example, gate unit 16 may check the user identity versus a black list and/or versus a white list. In case the key code is valid and the user is permitted (when permission is required), gate unit 16 may enable access into or out from gated area 14. In some cases gate unit 16 may receive a message from gated area server 12 that gated area 14 is full, and then gate unit 16 may not enable access into gated area 14. As mentioned above, gate units 16 may send a message to gated area server 12 every time access into or out from gated area 14 is enabled, for example, in order to keep a count of entries and exits to gated area 14. In some embodiments of the present invention, when gate unit 16 prevents access into gated area 14 because gated area 14 is full, gate unit 16 may send a notifying message to mobile unit 18, for example, over wireless connection 22. Mobile unit 18 may indicate to the user, for example, by the service provider's software application, the reason for the prevention.

Additionally, gate units 16 may send a message to service provider server 10 when access into or out from gated area 14 is enabled. Alternatively, in some embodiments of the present invention, when access into or out from gated area 14 is enabled, gate unit 16 may send a request message to mobile unit 18 to send a message to service provider server 10 for example, by the software application installed in mobile unit 18. The message to service provider server 10 may include, for example, relation of each entry and/or exit to the identification of the corresponding user. Service provider server 10 may gather the information about entries and exits of registered users. The service provider may debit registered users based on the entries and exits related to each of them.

The service provider associated with service provider server 10 may provide secured access service as described above to a plurality of gated areas 14 and may communicate with respective gate units 16 controlling access to these gated areas. Accordingly, users that register with service provider server 10 may be able to access a plurality of gated areas 14, for example, some or all of the gated areas 14 related to the service provider, by holding one or more valid and suitable key codes. In some embodiments, one valid key code may be suitable for access into several or all of the gated areas 14 related to the service provider.

Reference is now made to FIG. 2, which is a more detailed schematic illustration of gate unit 16 described above for controlling secured access to a gated area 14 according to embodiments of the present invention. Gate unit 16 may include an access control device 160 and a gate 164. Access control device 160 may include an antenna 161 to enable communications over a wireless connection such as, for example, a Bluetooth connection. Additionally, access control device 160 may include a controller 162 and a memory 163.

Antenna 161 may be adapted for receiving and transmitting communications with mobile units such as mobile unit 18, for example, by Bluetooth connection. By means of antenna 161, gate unit 16 may receive access request messages from mobile units such as mobile unit 18, which may include key codes and/or user identifications, as described above. Antenna 161 may be a directional antenna, e.g. an antenna which may receive and transmit signals only or most efficiently in a narrow angle and/or in a particular direction. This may enable communication with a mobile unit 18 coming from a certain direction with minimum risk of receiving communications from other mobile units such as, for example, a mobile unit 18 transmitting a message intended for another gate unit 16.

Controller 162 may process the request message received through antenna 161 and according to the request message may control gate 164. For example, controller 162 may check the validity of the received key code and/or the identity of the user, and enable access to and/or exit from gated area 14, for example, by opening gate 164, in case the key code is valid and/or in case the identified user is permitted. Controller 162 may send a message to gated area server 12 every time access to and/or exit from gated area 14 is enabled, thus, for example, enabling gated area server 12 to keep trace of changes in occupancy of gated area 14.

Additionally, controller 162 may receive information from gated area server 12 about, for example, the occupancy of gated area 14, such as how many free spaces are left in gated area 14 and/or how many additional entries may be allowed. As mentioned above, gated area server 12 may receive and gather information and updates from the various gate units 16 of gated area 14, for example, regarding entries to and exits from gated area 14. The occupancy information may be stored in memory 163 and may be updated, for example, by receiving information updates from gated area server 12 every time an exit from or entry into gated area 14 is occurring. In case gated area 14 is fully occupied, controller 162 may not activate gate 164, thus preventing access into gated area 14.

In some embodiments of the present invention, controller 162 may receive from gated area server 12 information regarding access permissions to users. For example, gated area server 12 may send to controller 162 a black list and/or a white list as described above. The black list and/or a white list may be stored in memory 163 and may be updated, for example, by receiving information updates about the black list and/or white list from gated area server 12. Upon receipt of a request message from mobile unit 18, controller 162 may identify the user and check whether the identified user has permission to enter to gated area 14. For example, controller 162 may check the user identity versus a black list and/or versus a white list. In case the key code is valid and the user is permitted, gate unit controller 162 may activate gate 164 to enable access into or out from gated area 14. In case access is prevented, for example, because gated area 14 is fully occupied or because the user is not permitted, controller 162 may trigger a message to mobile unit 18, indicating the reason for the prevention. In some embodiments of the invention, the gate unit may query the server for information about a particular key code and/or user identification, but in the event that communication with the server is momentarily unavailable, the gate unit may refer to the black list or white list in memory.

When access into or out from gated area 14 is enabled, controller 162 may send a message to service provider server 10. As described above, the message to service provider server 10 may include, for example, relation of each entry and/or exit to the identification of the corresponding user, for example, in order to enable service provider server 10 to charge money from users. Alternatively, for example, when there is no communication or when there is a flawed communication between controller 162 and service provider server 10, controller 162 may send a request message to mobile unit 18 to send a message to service provider server 10 for example, by the software application installed in mobile unit 18.

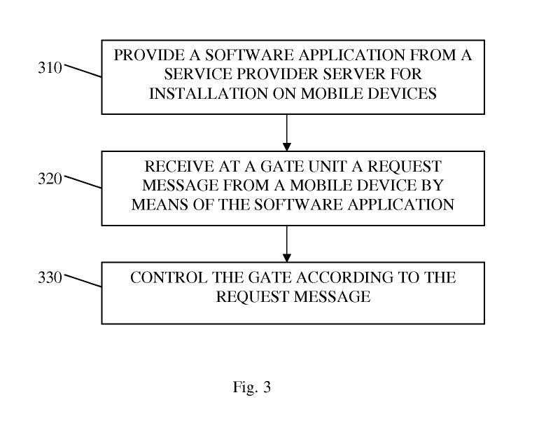

Reference is now made to FIG. 3, which is a flowchart illustrating a method for secured access to a gated area according to embodiments of the present invention. As indicated in block 310, the method may include providing a software application from service provider server 10 for installation on mobile devices such as mobile device 18, for example, over wireless connection 20 as described above. Service provider server 10 may further provide key codes for storing in said mobile devices, as described in detail above. Upon request from a user mobile device 18, the software application may check for validity of the key code stored in mobile device 18 and enable transmission of a request message from mobile device 18 in case the key code is valid. As indicated in block 320, the method may include receiving at gate unit 16 a request message from mobile device 18 by means of the installed software application, for example, over wireless connection 22 as described above. As described in detail above, the request messages may include a key code provided by the service provider server and an identification of the user of mobile device 18.

As indicated in block 330, the method may include controlling gate 164 according to the request message, for example, as described in detail above with reference to FIGS. 1 and 2. As described above, gated area server 12 may communicate with gate units 16 for gathering information about occupancy gated area 14 and for providing the occupancy information to gate units 16, which may control their respective gates according to the occupancy information. Additionally, gated area server 12 may provide to gate units 16 information about access permissions to users, wherein gate units 16 may further control their respective gates according to the access permissions information. Upon receiving of a request message from mobile device 18, gate unit 16 may identify the user and decide whether to enable access to gated area 14 based on whether the key code is valid and/or based on the user's identity and/or based on occupancy of gated area 14. In case access to gated area 14 is prevented by gate unit 16, gate unit 16 may send a message to mobile device 18 about the prevention.

Additionally, service provider server 10 may receive a message upon every exit from or entry to gated area 14, including relation of each entry and exit to an identification of a corresponding user, and thus, for example, may gather information about entries and exits of registered users. As described in detail above, the message may be triggered by gate unit 16 and may be sent by gate unit 16 and/or mobile device 18.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for secured access to gated areas, the system comprising:
a service provider server to provide a software application for installation on mobile devices; and
a plurality of gate units, each gate unit comprising a gate controlling access to a gated area and an access control device to control said gate according to request messages received from said mobile devices by means of said software application.

2. The system according to claim 1, further comprising a gated area server associated with a corresponding gated area and communicating with at least one of said plurality of gate units which relate to said corresponding gated area for gathering information about occupancy of said corresponding gated area.

3. The system according to claim 2, wherein said gated area server communicates with said related gate units for providing to said related gate units information about occupancy of said corresponding gated area, and wherein said related gate units further control their respective gates according to the occupancy information.

4. The system according to claim 2, wherein said gated area server communicates with said related gate units for providing to said related gate units information about access permissions to users, and wherein said related gate units further control their respective gates according to the access permissions information.

5. The system according to claim 1, wherein said service provider server is to provide key codes for storing in said mobile devices, and wherein said request messages include at least one of said key codes and an identification of the user of the respective mobile device.

6. The system according to claim 5, wherein upon request from a user of one of said mobile devices, said software application checks for validity of the key code stored in the mobile device and enables transmission of a request message from said mobile device in case the key code is valid.

7. The system according to claim 5, wherein upon receiving of a request message from a mobile device, the receiving gate unit identifies the user and decides whether to enable access to the corresponding gated area based on at least one of whether the key code is valid, the user's identity and the occupancy of the corresponding gated area.

8. The system according to claim 1, wherein upon prevention of access to a gated area by a gate unit, the gate unit communicates a message to the requesting mobile device about the prevention.

9. The system according to claim 1, wherein said service provider server is to gather information about entries and exits of registered users by receiving a message upon every exit from or entry to a gated area, the message including relation of each entry and exit to an identification of a corresponding user.

10. The system according to claim 9, wherein said message is triggered by the gate unit at which the exit or entry occurred and is sent by at least one of said gate unit and the requesting mobile device.

11. A method for secured access to gated areas, the method comprising:
providing a software application from a service provider server for installation on said mobile devices;
receiving at a gate unit a request message from a mobile device by means of said software application, said gate unit is one of a plurality of gate units, each comprising a gate controlling access to a gated area and an access control device to control said gate; and
controlling said gate according to said request message.

12. The method according to claim 11, further comprising communicating with at least one of said plurality of gate units which relate to a particular gated area for gathering information about occupancy of said particular gated area by a gated area server associated with said particular gated area.

13. The method according to claim 12, further comprising communicating with said related gate units for providing to said related gate units information about occupancy of said corresponding gated area by said gated area server, wherein said related gate units further control their respective gates according to the occupancy information.

14. The method according to claim 12, further comprising communicating with said related gate units for providing to said related gate units information about access permissions to users, wherein said related gate units further control their respective gates according to the access permissions information.

15. The method according to claim 11, further comprising providing by said service provider server key codes for storing in said mobile devices, wherein said request messages include at least one of said key codes and an identification of the user of the respective mobile device.

16. The method according to claim 15, further comprising, upon request from a user of one of said mobile devices, checking by said software application for validity of the key code stored in the mobile device and enabling transmission of a request message from said mobile device in case the key code is valid.

17. The method according to claim 15, further comprising, upon receiving of a request message from a mobile device, identifying the user by the receiving gate unit and deciding by the receiving gate unit whether to enable access to the corresponding gated area based on at least one of whether the key code is valid, the user's identity and the occupancy of the corresponding gated area.

18. The method according to claim 11, further comprising, upon prevention of access to a gated area by a gate unit, communicating by the gate unit a message to the requesting mobile device about the prevention.

19. The method according to claim 11, further comprising receiving by said service provider server a message upon every exit from or entry to a gated area, the message including relation of each entry and exit to an identification of a corresponding user, for gathering information about entries and exits of registered users.

20. The method according to claim 19, wherein said message is triggered by the gate unit at which the exit or entry occurred and is sent by at least one of said gate unit and the requesting mobile device.
